(19) United States
(12) Patent Application Publication
(10) Pub. No.: US 2005/0132032 A1
(43) Pub. Date: Jun. 16, 2005

(54) Autonomous agent-based system management

(76) Inventor: Daniel W. Bertrand, Oxford, MI (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/736,379

(22) Filed: Dec. 15, 2003

(51) Int. Cl. G06F 15/173

(52) U.S. Cl. 709/223

(57) ABSTRACT

A computer system (61) is provided herein which comprises a network (62) having a plurality of devices (63, 65, 69, 71) connected thereto, and an agent (77) installed on each of the devices. Each agent is adapted to monitor the state of the device it is installed on and to perform actions in accordance with a set of predefined rules in an attempt to achieve a set of predefined goals.

### TECHNICAL FIELD OF THE INVENTION

The present disclosure pertains generally to computer systems architectures, and more particularly to software for managing devices within such architectures.

### BACKGROUND OF THE INVENTION

Computer systems for business organizations have continued to evolve toward distributed computing environments in which data and processing are dispersed over a network that comprises many interconnected, diverse, and often geographically remote computers and associated devices. Such a computing environment is commonly referred to as an enterprise computing environment, or simply an enterprise. Software packages, known as enterprise management systems, are often utilized in an enterprise to monitor, analyze, and manage the resources of the enterprise. Enterprise management systems are typically adapted to collect data or metrics relating to system resources and the performance of individual devices that are distributed over the network.

As the size and complexity of computer systems in an enterprise grows, it becomes increasingly less effective and more inefficient to manage the system with a centralized architecture. Such an architecture causes the administration of these systems to be complex and costly, requires extensive use of network bandwidth, employs inherent latency in control to allow time for decision making to be done at the centralized system console, and introduces a vulnerability to loss of control if there is a loss of network connection to the central controller.

In some existing systems, monitoring agents are installed on all of the computer-based devices in the system, and these devices are configured to periodically gather pre-defined variables from the host device. The monitoring agents are then periodically polled by the central controller for updates on the status of the device. Such an approach is useful in that it facilitates the gathering of data from the computer-based devices on the system. However, the analysis and control logic in these systems is still retained at the central console, with the associated drawbacks noted above. While such an approach may work adequately in a small and stable environment, it quickly becomes inadequate in a large, dynamic and complex environment, because the burden on the central controller to effectively manage each of the devices for proper health and performance becomes excessive.

There is thus a need in the art for a method for monitoring and managing computers and other devices on a network managed by a central controller such that the burden on the central controller to understand the state of all devices under its control, and to allow each device on the network to understand its own state and goals and to adjust itself for optimal use, is relieved. There is further a need in the art for software and systems which implement such a method. These and other needs are met by the methodologies, software and systems disclosed herein and hereinafter described.

### SUMMARY OF THE INVENTION

In one aspect, a computer system is provided which comprises a network having a plurality of devices connected thereto, and an agent installed on each of the devices. Each agent, which is preferably a software module and which preferably operates in a continuous manner, is adapted to monitor (preferably continuously) the state of the device it is installed on and to perform actions in accordance with a set of predefined rules in an attempt to achieve a set of predefined goals. The agent installed on any one of the plurality of devices is preferably adapted to communicate with the agents installed on any other of the plurality of devices. The system is preferably equipped with a central controller, and each of the agents is adapted to determine, independent of the central controller, whether modifications to the operation of the device it is installed on are warranted. Each agent is also preferably adapted to communicate with the central controller to understand the overall behavior of the system and to retrieve information pertinent thereto. The agents may also be adapted to communicate with systems external to the network.

In another aspect, a computer system is provided which comprises a plurality of devices connected to a network, a central controller which controls the operation of the network, and a plurality of agents, each installed on one of the plurality of devices, which are in communication with each other and with said central controller. Each agent is adapted to monitor (preferably continuously) the state of the device it is installed on and to modify the operation of the device, in accordance with a set of predefined goals, so as to optimize the performance of the device. The system is preferably equipped with a central controller, and each of the agents is preferably adapted to determine, independent of the central controller, whether modifications to the operation of the device it is installed on are warranted. Preferably, the agent, which may be a software module, is installed on any one of the plurality of devices is adapted to communicate with the agents installed on any other of the plurality of devices.

In still another aspect, a method for managing a network is provided which comprises the steps of providing a network having a plurality of devices connected thereto, and installing, on each of the devices, an agent adapted to monitor the state of the device it is installed on and to perform actions in accordance with a set of predefined rules in an attempt to achieve a set of predefined goals. The agent installed on any one of the plurality of devices are preferably software modules and may be adapted to communicate with the agents installed on any other of the plurality of devices. The network may be equipped with a central controller, and each of the agents may be adapted to determine, independent of the central controller, whether modifications to the operation of the device it is installed on are warranted.

In yet another aspect, a computer system is provided which comprises a network containing a plurality of devices, wherein each of the devices has a tangible medium associated therewith, and a software program comprising a plurality of modules distributed over the tangible media. Each software module contains instructions for (a) monitoring the state of the device the module is installed on, and (b) performing actions in accordance with a set of predefined rules in an attempt to achieve a set of predefined goals. Preferably, each of the modules operates autonomously with respect to the other agents. The software modules are also preferably adapted to interact so as to optimize the overall performance of the network.

In a further aspect, a distributed, intelligent, autonomous, agent-based architecture for managing computer systems is provided. The architecture provides an agent, preferably in the form of a software module, which runs on each device to be managed. The agent software continuously monitors the state, health and performance of the host device and the goals of the system, and independently determines if modification is necessary to the device's operation. The software agent includes the ability to communicate with other known agents, with external systems, and with a centralized controller to understand overall behavior of the system and to retrieve pertinent information. The agent software can then operate independently of the centralized console.

One skilled in the art will appreciate that the various aspects of the present disclosure may be used in various combinations and sub-combinations, and each of those combinations and sub-combinations is to be treated as if specifically set forth herein.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is an illustration of a network that may be used in the implementation of the teachings disclosed herein;

FIG. 2 is an illustration of a computing system that may be used in the implementation of the teachings disclosed herein;

FIG. 3 is an illustration of some of the elements of an embodiment of an agent-based system for managing computer systems made in accordance with the teachings herein;

FIG. 4 is an illustration of the topology of one embodiment of an agent-based system for managing computer systems made in accordance with the teachings herein; and

FIG. 5 is an illustration of a distributed object load balancing system that can utilize the agent based approach described herein.

### DETAILED DESCRIPTION OF PREFERRED EMBODIMENT

It has now been found that the aforementioned needs may be met through the implementation of a distributed architecture that utilizes autonomous, intelligent, self-managing agents to handle the burden of managing an enterprise. In contrast to conventional management systems which are centralized and which do not use “intelligent”agents, in the architecture disclosed herein, the analysis and control logic is embedded in the agent itself and runs on the device it is managing (which may be a computer or any other network element such as, for example, a router) rather than residing in a centralized system console. The agents in this architecture have the ability to communicate with each other, are capable of acting independently and autonomously, and demonstrate emergent behavior as the agents act to respond to various conditions based on the goals of the system.

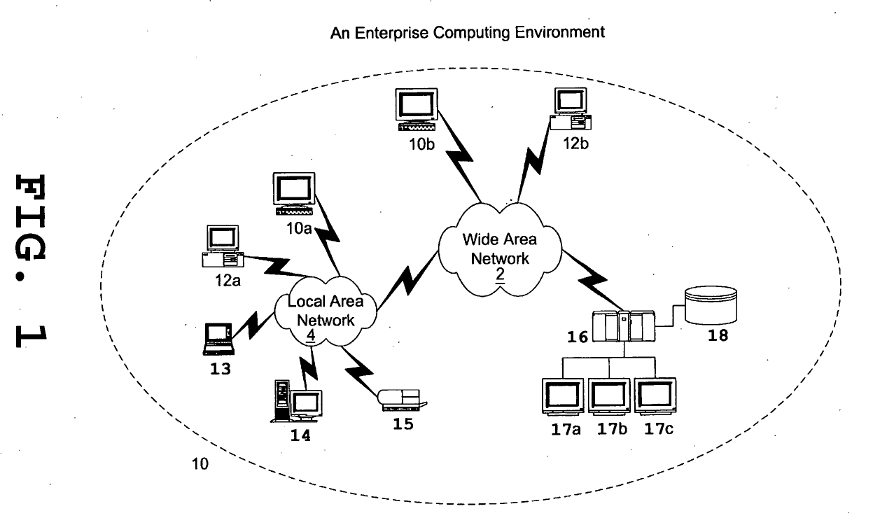

The methodologies described herein, and the software, systems, devices and architectures that implement or utilize these methodologies, are best understood by referring to FIGS. 1 through 5, like numerals being used for like and corresponding parts of the various drawings.

FIG. 1 illustrates an enterprise computing environment that may utilize the software, systems, methodologies, architectures and devices disclosed herein. The enterprise 1 comprises a plurality of computers and network devices which are connected by way of one or more networks. One skilled in the art will appreciate that the enterprise 1 may comprise a variety of heterogeneous computer systems and networks which are interconnected or configured in a variety of ways and which are adapted to run a variety of software applications. Hence, the enterprise depicted in FIG. 1 is merely illustrative and is not intended to be limiting.

The enterprise 1 may further comprise one or more local area networks (LANs) 4. As used herein, the term “LAN” refers to a network that spans a relatively small area. Frequently, a LAN 4 will be confined to a single location, such as a building or campus. Each node (that is, each individual computer system or device) on the network preferably has its own Central Processing Unit (CPU) that is adapted to execute programs, including the agent software disclosed herein, and each node may be adapted to access data and devices anywhere on the LAN 4. The LAN 4 thus allows many users to share devices and resources (such as scanners, printers and the like) and to share data stored on file servers. The LAN 4 may have various topologies (as used herein, the term “topology” refers to the geometric arrangement of devices on the network), and may utilize various protocols. The devices on the LAN may also communicate over various media, including, but not limited to, twisted-pair wire, coaxial cables, fiber optic cables, and radio waves. Although the enterprise 1 illustrated in FIG. 1 includes a single LAN 4, the methodologies, software, systems, architectures and devices described herein are not particularly limited to enterprises having any particular number of LANs. Thus, for example, in alternate embodiments, the enterprise 1 may include a plurality of LANs 4 which are coupled to one another through a wide area network (WAN) 2 (that is, a network that spans a relatively large geographical area).

Each LAN 4 in the enterprise may comprise a plurality of interconnected computer systems, which may include workstations 10a, personal computers 12a, laptops, notebook computer systems 14, and server computer systems 16. Each LAN may also comprise various network attached devices or peripherals, such as network printers 118 and scanners. The LAN 4 may be coupled to other computer systems, devices or LANs 4 by way of a WAN 2.

The enterprise 1 may also include one or more mainframe computer systems 16. In the particular embodiment depicted in FIG. 1, the mainframe 16 is coupled to the enterprise 1 through the WAN 2. It will be appreciated, however, that one or more mainframes 16 could also be coupled to the enterprise 1 through one or more LANs 4 or by other suitable means.

As shown in FIG. 1, the mainframe 16 is coupled to a storage device or file server 18 and mainframe terminals 17a, 17b, and 17c. The mainframe terminals 17a, 17b, and 17c are adapted to access data stored in the storage device or file server 18 coupled to, or included in, the mainframe computer system 16.

As previously noted, the enterprise 1 may also comprise one or more computer systems which are connected to the network through a WAN 2. Thus, in the particular embodiment illustrated in FIG. 1, the enterprise includes a workstation 10b and a personal computer 12b which are connected to the network via a WAN. The WAN may include computer systems which are geographically remote and which are connected to the enterprise 1 through the Internet.

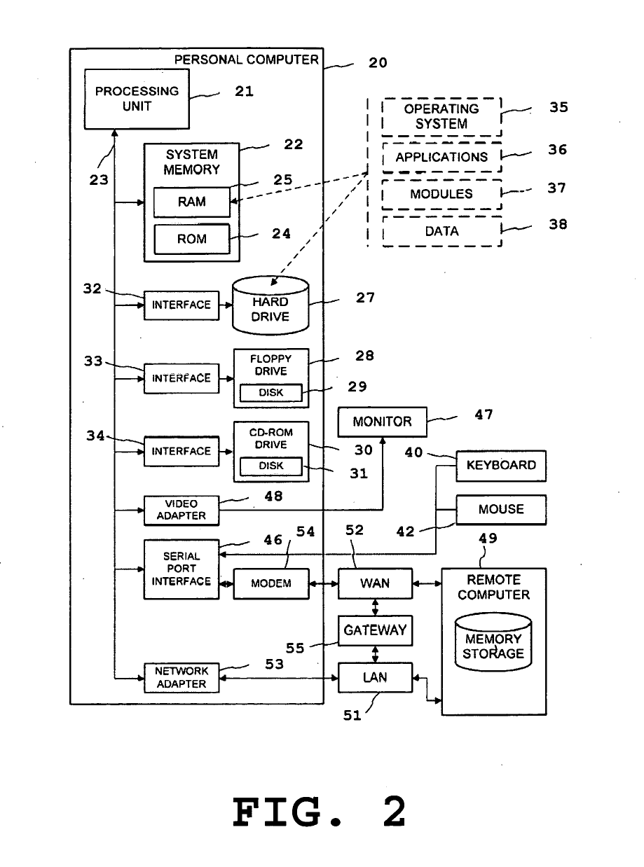

FIG. 2 depicts one example of a computer 20 that may be a component of an enterprise of the type described above, and which thus may be used in practicing or implementing the methods, systems, architectures and devices disclosed herein. As described in greater detail later, an autonomous agent may be installed on each computer and device incorporated into the enterprise. Thus, for example, the autonomous agent may be installed on the hard drive 27 of computer 20.

The computer 20 may be a general purpose computer which may be used as a stand-alone device or as part of a larger, networked system of personal computers of the type used in a business enterprise. The computer 20 may take various forms, and may be, for example, a personal computer, laptop, palmtop, set top, server, mainframe, or other type of computer. The computer includes a processing unit 21, system memory 22, and system bus 23 that couple various system components, including system memory 22, to the processing unit 21. Processing unit 21 may be any of various commercially available processors, including, but not limited to, Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 21.

System bus 23 may be any of several types of bus structures including a memory bus or memory controller, a peripheral bus, and a local bus using any of a variety of conventional bus architectures such as PCI, VESA, AGP, Microchannel, ISA and EISA, to name a few. System memory 22 includes read only memory (ROM) 24 and random access memory (RAM) 25. A basic input/output system (BIOS), containing the basic routines helping to transfer information between elements within the computer 20, such as during start-up, is stored in ROM 24.

Computer 20 may further include a hard disk drive 227, a floppy drive 28 adapted to read from or write to a removable floppy disk 29, and CD-ROM drive 30 adapted to read from and/or write to a CD-ROM disk 31 or other optical media. The hard disk drive 27, floppy drive 28, and CD-ROM drive 30 are connected to the system bus 23 by a hard disk drive interface 32, a floppy drive interface 33, and an optical drive interface 34, respectively. The drives and their associated computer-readable media provide nonvolatile storage of data, data structures, computer-executable instructions, and the like for computer 20. Although the description of computer-readable media provided above refers to a hard disk, a removable floppy and a CD, those skilled in the art will appreciate that other types of media which are readable by a computer, such as magnetic cassettes, flash memory cards, digital video disks, Bernoulli cartridges, and the like, may be used in the exemplary operating environment.

A number of program modules may be stored in the drives and RAM 25, including an operating system 35, one or more application programs 36, other program modules 37, and program data 38. A user may enter commands and information into the computer 20 through a keyboard 40 and pointing device, such as mouse 42. Other input devices (not shown) may include a microphone, joystick, game pad, satellite dish, scanner, or the like. These and other input devices are often connected to the processing unit 21 through a serial port interface 46 coupling to the system bus, but possibly connecting by other interfaces, such as a parallel port, game port or a universal serial bus (USB). A monitor 47 or other type of display device is also connected to the system bus 23 via an interface, such as a video adapter 48. In addition to the monitor, computers typically include other peripheral output devices (not shown), such as speakers and printers.

As noted above, computer 20 may operate in a networked environment using logical connections to one or more remote devices, such as a remote computer 49. Remote computer 49 may be a server, a router, a peer device or other common network node, and typically includes many or all of the elements described relative to the computer 20, although only a memory storage device 49 has been illustrated in FIG. 2. The logical connections depicted in FIG. 2 include a local area network (LAN) 51 and a wide area network (WAN) 52. Such networking environments are commonplace in offices, enterprise-wide computer networks, intranets and the Internet.

When used in a LAN networking environment, the computer 20 may be connected to the LAN 51 through a network interface or adapter 53. When used in a WAN networking environment, computer 20 typically includes a modem 54 or other means for establishing communications (e.g., via the LAN 51 and a gateway or proxy server) over the wide area network 5.2, such as the Internet. Modem 54, which may be internal or external, is connected to the system bus 23 via the serial port interface 46. In a networked environment, program modules depicted relative to the computer 20, or portions thereof, may be stored in a remote computer 49 or in a memory storage device associated therewith.

Those skilled in the art will appreciate that the network connections shown are exemplary, and that other means of establishing a communications link between the computers may be used. FIG. 2 provides merely one of many possible examples of a computer useful for the implementation or use of the methodologies, software and systems described herein. In particular, it is to be noted that the methodologies, software and systems described herein may be implemented by, or used in conjunction with, computers other than general-purpose computers, as well as general-purpose computers without conventional operating systems.

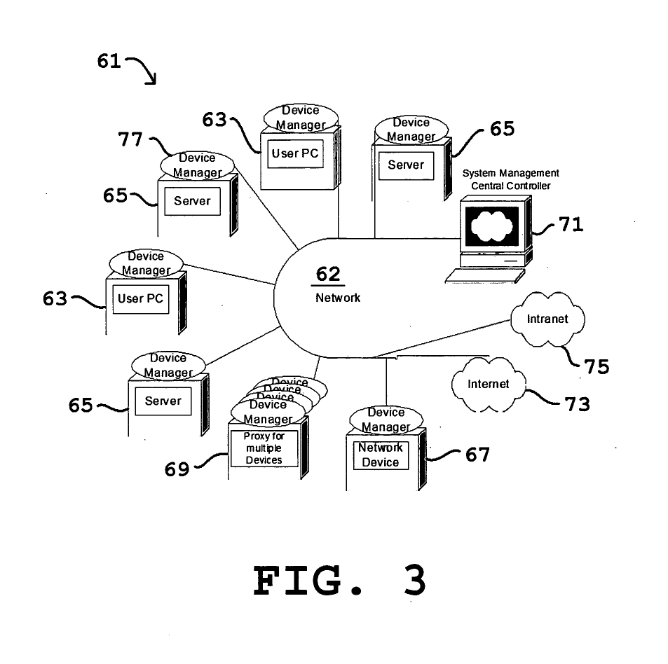

FIG. 3 illustrates the general architecture of one particular, non-limiting embodiment of a system employing autonomous agents that may be constructed in accordance with the teachings herein. The system 61 includes a plurality of devices that are interconnected by way of a network 62. The devices include user PCs 63, servers 65, network devices 67, and proxy servers 69 for multiple devices. The network itself is managed by a central controller 71, and may be in communication with the Internet 73 and with one or more Intranets 75.

Each device on the system, including the user PCs 63, servers 65, network devices 67, and proxy servers 69 (which may be used to host agents for devices incapable of physically hosting or running the agent) is loaded with and/or assigned an agent or device manager 77. These agents are goal-oriented and sufficiently intelligent to manage the effective operation of the device they are tasked to manage. Analysis and control logic is embedded in the agent software and executes on the host device. Consequently, the agent is adapted to act as the management “brain” of the host device, and is further adapted to automatically learn the details of the host device (such as machine type and all software residing on it), to understand the goals of the enterprise and system, to understand its own status and health, and then, based on this knowledge, to determine what (if any) appropriate action should be taken to ensure that the host device and/or the network is operating with maximum efficiency and effectiveness.

As a specific example of how the autonomous agent may function, on a database server, the agent may detect on its own that the version of the database software is not at the most recent patch level. It may further detect that a security vulnerability exists, and that the vulnerability could be eliminated or fixed by applying a recent software patch. After understanding its existing circumstance with patch levels and security vulnerabilities, the agent would then examine its goals and find that one goal is to keep itself protected from security breaches. Based on this situation, it may automatically, or with manual intervention, contact the appropriate server to receive the updated database patch and then request a patch load and server reboot with the administration team.

The systems, devices and methodologies disclosed herein remove the burden imposed on a centralized system to continually maintain an understanding of the state of all devices under its control, to allow each device to know itself and its goals, and to adjust itself for optimal use. Rather, most or all of these functions can be addressed on the device level, hence freeing the central controller to perform other tasks, and shielding the individual devices from some of the effects of network disruption.

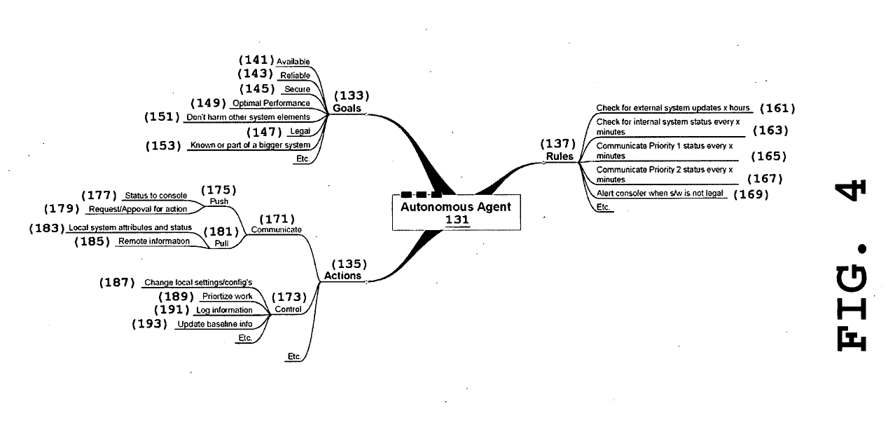

FIG. 4 illustrates some of the elements or attributes that might be associated with an agent in an autonomous agent based system of the type described herein. The agent 131 has a set of predefined goals 133 associated therewith which it attempts to accomplish by performing a series of actions 135 in accordance with a set of predefined rules 137.

The goals are the highest level requirements of the agent. The agent will continually attempt to act, within the constraints set forth in the rules, to achieve these objectives. Examples of some possible goals include maintaining the device in a state where it is available (141), reliable (143), and secure (145), is functioning legally (147) and at an optimal level of performance (149), is not harming other elements of the system (151), and is operating as a part of a bigger system (153). Of course, one skilled in the art will appreciate that various other goals are also possible. These goals may also have various weightings or prioritizations to permit resolution in instances where the goals may be in conflict such that the agent must choose between them. In some embodiments, the goals may change over time, either due to adaptive behavior programmed into the agent or due to the imposition of new or revised goals on the agent by the central controller.

The rules govern the agent's actions in accordance with the goals specified for the agent. Examples of some possible rules include checking for external system updates (161) at specified intervals, checking the internal system status (163) at specified intervals, communicating priority 1 status (165) at specified intervals, communicating priority 2 status (167) at specified intervals, and alerting the central controller when the device performs illegal actions (169). Of course, one skilled in the art will appreciate that various other rules are possible. These rules may also have various weightings or prioritizations to permit resolution in instances where the rules may be in conflict such that the agent must choose between them. In some embodiments, the rules may change over time, either due to adaptive behavior programmed into the agent or due to the imposition of new or revised rules on the agent by the central controller.

The actions are the activities the agent can initiate based on the execution of the rules. These actions may be, for example, communications related actions (171) and control related actions (173). Examples of some possible communications related actions include push actions (175), such as sending device status to (177), and requesting approval for actions from (179), the central controller, and pull actions (181), such as gathering local system attributes and status (183), and gathering remote information (185). Examples of some possible control related actions include changing local settings or configurations (187), prioritizing work (189), logging information (191), and updating baseline information (193). Of course, one skilled in the art will appreciate that various other actions are also possible.

The agents described herein are preferably adapted to function continuously and autonomously in an environment that may be inhabited by other agents and processes. Consequently, these agents are preferably adapted to carry out activities in a flexible and intelligent manner that is responsive to changes in the environment, without requiring constant guidance or intervention by either the central controller or by the personnel managing the system. It is also preferred that the agents are adapted to learn from their experiences, and to be able to communicate and cooperate with other agents.

Consistent with the goals and rules prescribed for an agent, each agent may be adapted to possess, to a greater or lesser degree, any of the following attributes:
(1) Reactivity: the ability to selectively sense the occurrence of one or more events and to act in response thereto;
(2) Autonomy: goal-directedness, proactive and self-starting behavior;
(3) Collaborative behavior: the ability to work in concert with other agents to achieve a common goal;
(4) Knowledge-level communication ability: the ability to communicate with persons and with other agents with language more resembling humanlike speech acts than typical symbol-level program-to-program protocols;
(5) Inferential capability: the ability to act on abstract task specification using prior knowledge of general goals and preferred methods to achieve flexibility; this characteristic extends beyond the information given; and may have explicit models of self, user, situation, and/or other agents;
(6) Temporal continuity: persistence of identity and state over long periods of time;
(7) Personality: the capability of manifesting the attributes of a believable character, such as emotion;
(8) Adaptivity: being able to learn and improve with experience; and
(9) Mobility: being able to migrate in a self-directed way from one host platform to another.

The various methods, systems, software and devices disclosed herein may utilize one or more groups of agents that perform different simple functions but that can exchange information and derive more complex results than any one of them may be able to obtain on their own. Consequently, if one agent stops working for any reason, there are two possible outcomes: (a) if the agent is truly independent and produces results on its own, only its results will be lost, and all other agents will continue to work normally; or (b) if the data produced by the agent was needed by other agents, that group of agents may be impeded from working properly. In either case, the damage will be restricted to, at most, a set of agents on the network, and the remaining agents can continue to work normally. Thus, if the agents are properly organized in mutually independent sets, problems relating to single points of failure are reduced. The agents may also be organized in a hierarchical structure with multiple layers of agents reducing data and reporting it to the upper layers, thus making the system scalable.

The use of autonomous agents across a network is also advantageous in that it provides the ability to start and stop agents independently of each other. Consequently, in many cases, programs or processes which rely upon the agents may be reconfigured or modified without having to restart them. In particular, if the process relies on a given set of agents, it will often be possible to restart or reconfigure the appropriate agents without disturbing the ones that are already running. Similarly, agents that are no longer needed can be stopped, and agents that need to be reconfigured can be sent the appropriate commands without having to restart the whole process. Moreover, because agents can be stopped and started without disturbing the rest of the process, agents can be upgraded as increased functionality is required from them. As long as their external interface remains unchanged (or is backward-compatible), other agents or components of the network need not even know that the agent has been upgraded.

The use of autonomous agents is also advantageous in that the agents can be programmed arbitrarily. Hence, the agent can be adapted to obtain its data from an audit trail, by probing the system where it is running, by capturing packets from a network, or from any other suitable source. Moreover, if agents are implemented as separated processes on a host, each agent can be implemented in the programming language that is best suited for the task that it has to perform.

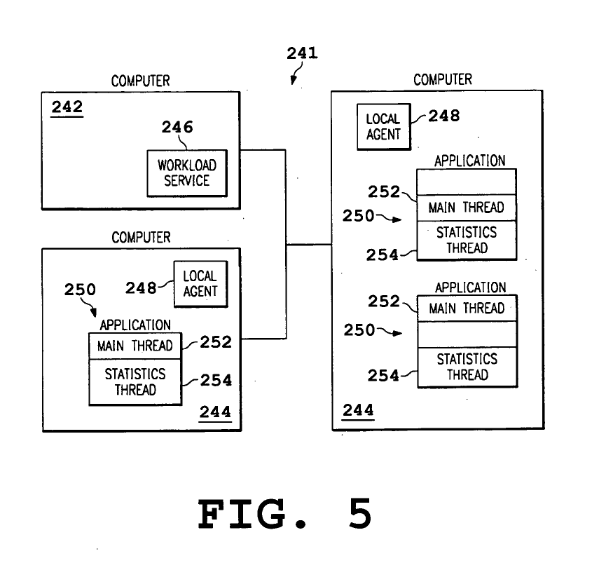

One advantage of an agent-based hierarchy of the type described herein is that it can be used to efficiently apply resources distributed across a network so as to balance the load placed on various network devices. FIG. 5 illustrates a non-limiting example of a distributed object load balancing system 241 of this type. This system also illustrates how autonomous agents can interact and cooperate to achieve a common system goal.

The distributed object load balancing system 241 comprises computer 242 with workload service 246 software running on it. Workload service 246 is operable to receive performance statistics for various application processes running in the distributed object system. Workload service 246 may then be used to determine which of the plurality of computers 242, 244 in the system should be used to create a new object in the memory of one of the computers 242, 244 where the new object comprises a part of the distributed object system. Although workload service 246 could be designed with many different goals in mind, workload service 246 preferably causes objects in a distributed object system to be created in the memory of one of the computers 242, 244 in such a way as to balance the workload of each of the computers 242, 244. The system is thus able to adapt to varying traffic patterns in the system and make efficient use of various available resources.

The workload service 246 collects detailed statistical information about what different objects are active in different processes, the computer 242, 244 on which the objects reside, what methods have been invoked on them, how many times those methods have been invoked, and how much time has been spent in executing the methods. In some embodiments, the amount of time spent for a given method is measured in terms of CPU time, but it could be measured by other types of time measurements as well.

The distributed object load balancing system allows statistics gathering for the aggregate of all objects of a particular type. For example, a bank attempting to keep track of customer accounts in a distributed object system may have a customer object. Suppose that the bank has only three customers A, B & C. Workload service 246 may maintain the statistics for objects A, B and C, separately, and may also maintain cumulative numbers for all customers. Thus, workload service 246 may maintain the above-described statistics for all customer objects cumulatively, as well as other statistics on a cumulative basis. Average statistics for all instances of a given object class might also be maintained by workload service 246. Thus, when workload service 246 attempts to determine which computer 242, 244 should contain a distributed object in its memory, the workload service 246 may take into account not only the present workload of the computers 242, 244 in the distributed object system, but may also make the decision based upon a prediction of the resources that will be consumed by the new object due to the average workload that objects of that particular object class have previously imposed on computers 242, 244.

Because the application processes 250 running on computers 242, 244 may be performing critical tasks, statistics gathering is preferably conducted without interfering with the operation of these application processes 250. It is to be noted, of course, that an actual application may comprise many application processes 250. The system achieves this goal by providing a statistics thread 254 within each application process 250 to be responsible for gathering statistics. Statistics thread 254 may be transparent to an application developer who is developing a distributed object system application process 250. A distributed object framework may be provided to an application developer such that statistics thread 254 is automatically incorporated into an application process 250 when the application developer chooses to use that framework. Statistics thread 254 avoids interfering with the function of application process 250 by running asynchronously and avoiding interruption of the actual business tasks being conducted by application process 250. In this example, application process 250 is a multi-threaded application process comprising a statistics thread 254 and a main thread 252. Main thread 252 and any other application threads may be used to perform whatever task for which application process 250 is designed to perform. Additional threads could also be included.

In the embodiment depicted, an interceptor thread (not explicitly shown) for each application process 250 intercepts messages intended for objects of application process 250. The interceptor thread is responsible for informing an object to update its performance statistics upon completion of a given operation. Thus, application process 250 instructs its own objects to gather performance statistics regarding themselves. Each object has access to a statistics data structure in memory of the computer 242, 244 on which it is running. The statistics data structure for a given application process 250 resides in the memory space for that application process 250. When an object completes an operation, it updates the statistics data structure with the statistics described above in connection with workload service 246. One option for avoiding interference with the operation of application process 550 is to only maintain performance statistics for messages received by application process 250 that originated outside of the application process 250.

Statistics thread 254 may be configured by the developer of application process 250 to periodically wake up, gather the statistics on objects currently residing in the memory of the computer 242, 244 on which the application process 250 is executing, and send these statistics to workload service 246 through local agent 248. Statistics thread 254 may be programmed to send either an empty message or no message at all to local agent 248 if no new statistics have been generated since the last time statistics thread 254 woke up. Such an action may be considered to be part of the process of waking up and forwarding of statistics. Thus, when this application refers to periodically waking up and obtaining performance statistics, that action encompasses obtaining no information during some of the periods. Eventually, the statistics thread will obtain a performance statistic during one of the periodic wake up times. The statistics thread gathers statistics on objects residing in the memory space of the application process 250 with which it is associated. In this embodiment, statistics thread 254 wakes up periodically, accesses the data structure containing the statistical data and sends the statistical information to local agent 248. Statistics thread 254 then goes to sleep. The time between the periods of statistics gathering by statistics gathering thread 254 may be adjustable either during development of application process 250 or by a system administrator during use of application process 250.

Local agent 248 receives performance statistics from various statistics threads 254 and relays those statistics to workload service 246. The invention thus avoids interference with application process 250. In a distributed object network environment, no assumptions can be made about the speed of the network and the availability of various services on the network. In addition, statistics data is eventually reported from many different local agents 248 to a central workload service 246. Because the workload service 246 may be busy receiving data from several local agents 248, it may delay the reporting of data from other local agents 248. Because local agents 248 receive their data from statistics threads 248 resident on the same computer 242, 244, local agent 248 may receive the statistical data immediately from the statistics thread 248, freeing up the application process 250 to continue performing its function. Local agent 248 may save the statistics data on a persistent storage medium and relay it to workload service 246 when the network is not busy or when workload service 246 is ready to receive the data. In an alternative embodiment, statistics thread 248 could perform the functions of local agent 248 such as forwarding statistics to the workload service.

Although the operation of distributed object load balancing system 241 has been described above, it will now be briefly summarized for an example embodiment. Each application process 250 maintains performance statistics regarding its objects resident in memory of the computer 242, 244 that is running the application process 250. Periodically, statistics thread 254 wakes up and relays those statistics to local agent 248. Local agent 248 relays the performance statistics to workload service 246. When it is desired to instantiate a new application object, the decision of which application process 250 is to instantiate and contain the new application object is based upon performance statistics maintained by workload service 246. Any suitable formula or algorithm may be used for this determination.

A distributed architecture has been provided herein that utilizes autonomous, intelligent, self-managing agents to handle the burden of managing an enterprise. In contrast to conventional centralize management systems which do not use “intelligent” agents, in the architecture disclosed herein, the analysis and control logic is embedded in the agent itself and runs on the device it is managing rather than residing in a centralized system console. The agents in this architecture have the ability to communicate with each other, are capable of acting independently and autonomously, and demonstrate emergent behavior as the agents act to respond to various conditions based on the goals of the system.

Although the methods, software, systems, architectures and devices disclosed herein have been described in detail, it should be understood that various changes, substitutions and alterations can be made hereto without departing from the spirit and scope of the invention.

1. A computer system, comprising:
a network having a plurality of devices connected thereto; and
an agent installed on each of said devices;
wherein each agent is adapted to monitor the state of the device it is installed on and to perform actions in accordance with a set of predefined rules in an attempt to achieve a set of predefined goals.

2. The system of claim 1, wherein the agent installed on any one of said plurality of devices is adapted to communicate with the agents installed on any other of the plurality of devices.

3. The system of claim 1, wherein said agents are software modules.

4. The system of claim 1, wherein said system is equipped with a central controller, and wherein each of said agents is adapted to determine, independent of the central controller, whether modifications to the operation of the device it is installed on are warranted.

5. The system of claim 1, wherein said agents operate in a continuous manner.

6. The system of claim 1, wherein said agents are adapted to continuously monitor the state of the devices they are installed on.

7. The system of claim 1, wherein said agents are adapted to communicate with systems external to the network.

8. The system of claim 1, wherein said system is equipped with a central controller, and wherein said agents are adapted to communicate with said central controller to understand the overall behavior of the system and to retrieve information pertinent thereto.

9. A computer system, comprising:
a plurality of devices connected to a network;
a central controller which controls the operation of the network; and
a plurality of agents, each installed on one of said plurality of devices, which are in communication with each other and with said central controller;
wherein each agent is adapted to monitor the state of the device it is installed on and to modify the operation of the device, in accordance with a set of predefined goals, so as to optimize the performance of the device.

10. The system of claim 9, wherein said system is equipped with a central controller, and wherein each of said agents is adapted to determine, independent of the central controller, whether modifications to the operation of the device it is installed on are warranted.

11. The system of claim 9, wherein the agent installed on any one of said plurality of devices is adapted to communicate with the agents installed on any other of the plurality of devices.

12. The system of claim 9, wherein said agents are software modules.

13. The system of claim 9, wherein said agents are adapted to continuously monitor the state of the devices they are installed on.

14. A method for managing a network, comprising the steps of:
providing a network having a plurality of devices connected thereto; and
installing, on each of said devices, an agent adapted to monitor the state of the device it is installed on and to perform actions in accordance with a set of predefined rules in an attempt to achieve a set of predefined goals.

15. The method of claim 14, wherein the agent installed on any one of said plurality of devices is adapted to communicate with the agents installed on any other of the plurality of devices.

16. The method of claim 14, wherein said agents are software modules.

17. The method of claim 14, wherein said network is equipped with a central controller, and wherein each of said agents is adapted to determine, independent of the central controller, whether modifications to the operation of the device it is installed on are warranted.

18. A computer system, comprising:
a network containing a plurality of devices, each of said devices having a tangible medium associated therewith; and
a software program comprising a plurality of modules distributed over the tangible media, each software module containing instructions for (a) monitoring the state of the device the module is installed on, and (b) performing actions in accordance with a set of predefined rules in an attempt to achieve a set of predefined goals.

19. The system of claim 18, wherein each of said modules operates autonomously with respect to the other agents.

20. The system of claim 18, wherein said software modules are adapted to interact so as to optimize the overall performance of the network.
